(19) United States
(12) Patent Application Publication
(10) Pub. No.: US 2015/0102955 A1
(43) Pub. Date: Apr. 16, 2015

(54) MEASUREMENT ASSOCIATION IN VEHICLES

(71) Applicant: GM GLOBAL TECHNOLOGY OPERATIONS LLC, Detroit, MI (US)

(72) Inventors: KEVIN A. O'DEA, ANN ARBOR, MI (US); SHUQING ZENG, STERLING HEIGHTS, MI (US); JAMES N. NICKOLAOU, CLARKSTON, MI (US); BRADLEY HAMNER, PITTSBURGH, PA (US)

(73) Assignee: GM GLOBAL TECHNOLOGY OPERATIONS LLC, Detroit, MI (US)

(21) Appl. No.: 14/053,205

(22) Filed: Oct. 14, 2013

(51) Int. Cl. G01S 7/41

(52) U.S. Cl. CPC G01S 7/41
USPC 342/70

(57) ABSTRACT

Methods and systems are provided for measurement association in vehicles. An object proximate a vehicle is identified. Measurements or classifications are obtained via one or more sensors. A first tracking gate is generated that is based at least in part on a characteristic of one of the sensors used to obtain the measurements or classifications. A second tracking gate is generated that is based at least on part on the first tracking gate and a measurement history.

### TECHNICAL FIELD

The present disclosure generally relates to the field of vehicles and, more specifically, to methods and systems for associating measurements in vehicles, such as automobiles.

### BACKGROUND

Many vehicles today have systems that track a position or movement of objects (for example, other vehicles) that may be in proximity to the vehicle. Such systems may include, by way of example, adaptive cruise control (ACC) systems, avoidance systems, active braking systems, active steering systems, driver assist systems, warning systems, and the like. However, it may be difficult in certain situations to provide optimal tracking of such objects over time.

Accordingly, it is desirable to provide improved methods and system for measurement association in vehicles, for example with respect to measurements pertaining to detected objects that may be in proximity to the vehicle. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises identifying an object proximate a vehicle, obtaining one or more measurements or classifications that may potentially be associated with the object via one or more sensors, generating a first tracking gate that is based at least in part on a characteristic of one of the sensors used to obtain the measurements or classifications, and generating a second tracking gate that is based at least on part on the first tracking gate and a measurement history.

In accordance with another exemplary embodiment, a method is provided. The method comprises obtaining initial first measurements via a first type of sensor, obtaining initial second measurements via a second type of sensor that is different from the first type of sensor, generating a fusion system incorporating the initial first measurements and the initial second measurements, generating a predicted value using the initial first measurements, the initial second measurements, and the fusion system, obtaining additional measurements via the first type of sensor, the second type of sensor, or both, and comparing the predicted value with the additional measurements.

In accordance with a further exemplary embodiment, a system is provided. The system comprises one or more sensors and a processor. The one or more sensors are configured to provide one or more measurements. The processor is coupled to the one or more sensors, and is configured to at least facilitate identifying an object proximate a vehicle, generating a first tracking gate that is based at least in part on a characteristic of one of the sensors used to obtain the measurements, and generating a second tracking gate that is based at least on part on the first tracking gate and a measurement history.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a system used for associating measurements of objects detected in proximity to a vehicle, in accordance with an exemplary embodiment;

FIG. 2 is a functional block diagram of the system for associating measurements of objects detected in proximity to a vehicle of FIG. 1, in accordance with an exemplary embodiment;

FIG. 3 is a flowchart of a process for associating measurements of objects detected in proximity to a vehicle, and that can be used in connection with the vehicle of FIG. 1 and the system of FIGS. 1 and 2, in accordance with an exemplary embodiment;

FIG. 4 is a diagram of an illustration of exemplary tracking gates pertaining to the process of FIG. 3 and the vehicle of FIG. 1 and the systems of FIGS. 1 and 2, in accordance with an exemplary embodiment; and

FIG. 5 is a flowchart of an additional process for associating measurements of objects detected in proximity to a vehicle, and that can be used in connection with the process of FIG. 3, the vehicle of FIG. 1, and the system of FIGS. 1 and 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

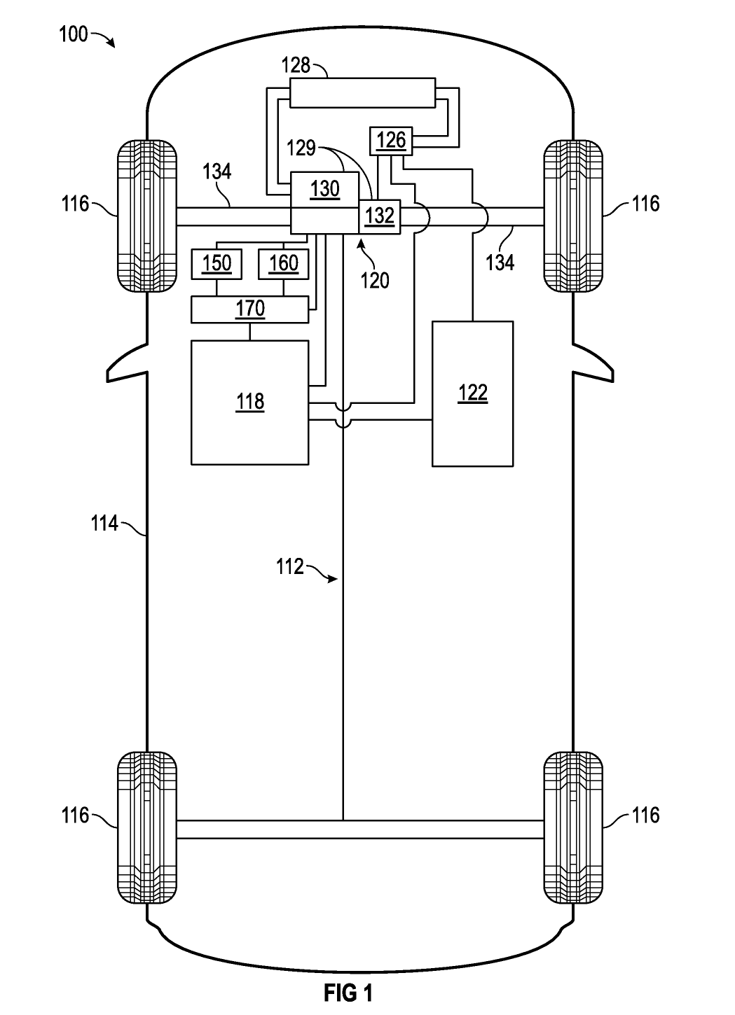

FIG. 1 illustrates a vehicle 100, or automobile, according to an exemplary embodiment. The vehicle 100 is also referenced at various points throughout this application as the vehicle. As described in greater detail further below, the vehicle 100 includes a control system 170 for associating measurements pertaining to objects that may be detected proximate the vehicle 100.

As depicted in FIG. 1, the vehicle 100 includes a chassis 112, a body 114, four wheels 116, an electronic control system 118, a steering system 150, a braking system 160, and the above-referenced control system 170. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114.

The vehicle 100 (as well as each of the target vehicles and third vehicles) may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

In the exemplary embodiment illustrated in FIG. 1, the vehicle 100 is a hybrid electric vehicle (HEV), and further includes an actuator assembly 120, an energy storage system (ESS) 122, a power inverter assembly (or inverter) 126, and a radiator 128. The actuator assembly 120 includes at least one electric propulsion system 129 mounted on the chassis 112 that drives the wheels 116. In the depicted embodiment, the actuator assembly 120 includes a combustion engine 130 and an electric motor/generator (or motor) 132. As will be appreciated by one skilled in the art, the electric motor 132 includes a transmission therein, and, although not illustrated, also includes a stator assembly (including conductive coils), a rotor assembly (including a ferromagnetic core), and a cooling fluid or coolant. The stator assembly and/or the rotor assembly within the electric motor 132 may include multiple electromagnetic poles, as is commonly understood.

Still referring to FIG. 1, the combustion engine 130 and the electric motor 132 are integrated such that one or both are mechanically coupled to at least some of the wheels 116 through one or more drive shafts 134. In one embodiment, the vehicle 100 is a “series HEV,” in which the combustion engine 130 is not directly coupled to the transmission, but coupled to a generator (not shown), which is used to power the electric motor 132. In another embodiment, the vehicle 100 is a “parallel HEV,” in which the combustion engine 130 is directly coupled to the transmission by, for example, having the rotor of the electric motor 132 rotationally coupled to the drive shaft of the combustion engine 130.

The ESS 122 is mounted on the chassis 112, and is electrically connected to the inverter 126. The ESS 122 preferably comprises a battery having a pack of battery cells. In one embodiment, the ESS 122 comprises a lithium iron phosphate battery, such as a nanophosphate lithium ion battery. Together the ESS 122 and electric propulsion system(s) 129 provide a drive system to propel the vehicle 100.

The radiator 128 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the combustion engine 130 and the inverter 126.

The steering system 150 is mounted on the chassis 112, and controls steering of the wheels 116. The steering system 150 includes a steering wheel and a steering column (not depicted). The steering wheel receives inputs from a driver of the vehicle. The steering column results in desired steering angles for the wheels 116 via the drive shafts 134 based on the inputs from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, inputs via a cruise control resume switch (not depicted), and various other inputs for various vehicle devices and/or systems, such as one or more vehicle radios, other entertainment systems, environmental control systems, lightning units, navigation systems, and the like (also not depicted). In a preferred embodiment, the braking system 160 includes both a regenerative braking capability and a friction braking capability for the vehicle 100.

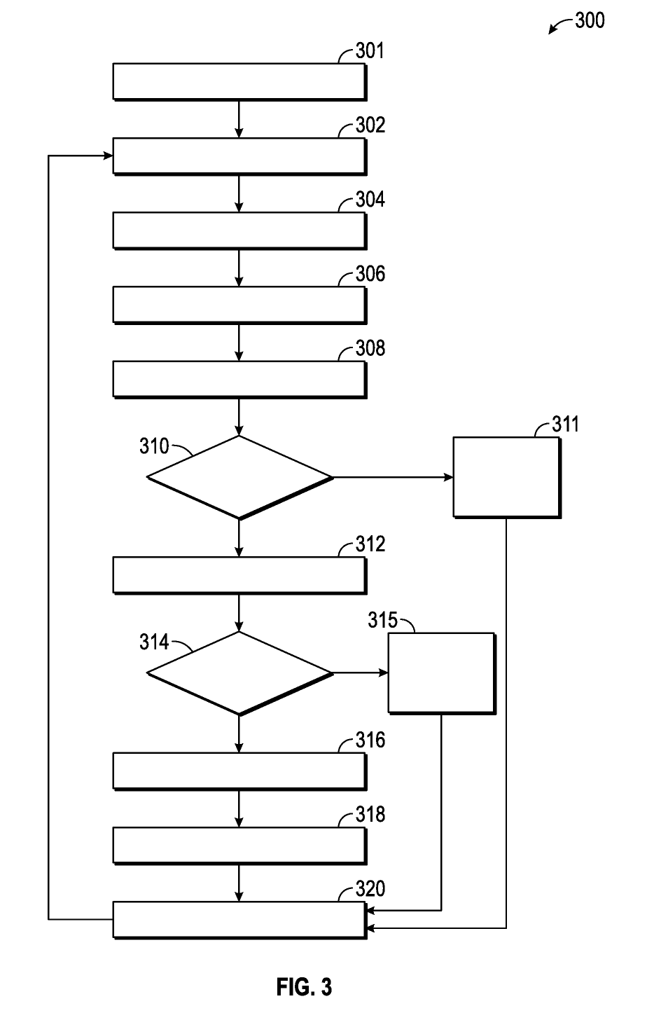

The control system 170 is mounted on the chassis 112. The control system 170 may be coupled to various other vehicle devices and systems, such as, among others, the actuator assembly 120, the steering system 150, the braking system 160, and the electronic control system 118. The control system 170 detects and tracks objects that may be proximate the vehicle 100, including the tracking of positions and movements of such objects. In addition, the control system 170 associates measurements pertaining to such objects using multiple tracking gates in executing the steps of the processes 300, 500 set forth in FIGS. 3-5 and described in greater detail further below. In one embodiment, the control system 170 may comprise or incorporate features and/or components of one or more of the following types of systems, among others: an adaptive cruise control (ACC) system, an avoidance system, an active braking system, an active steering system, a driver assist system, and/or a warning system.

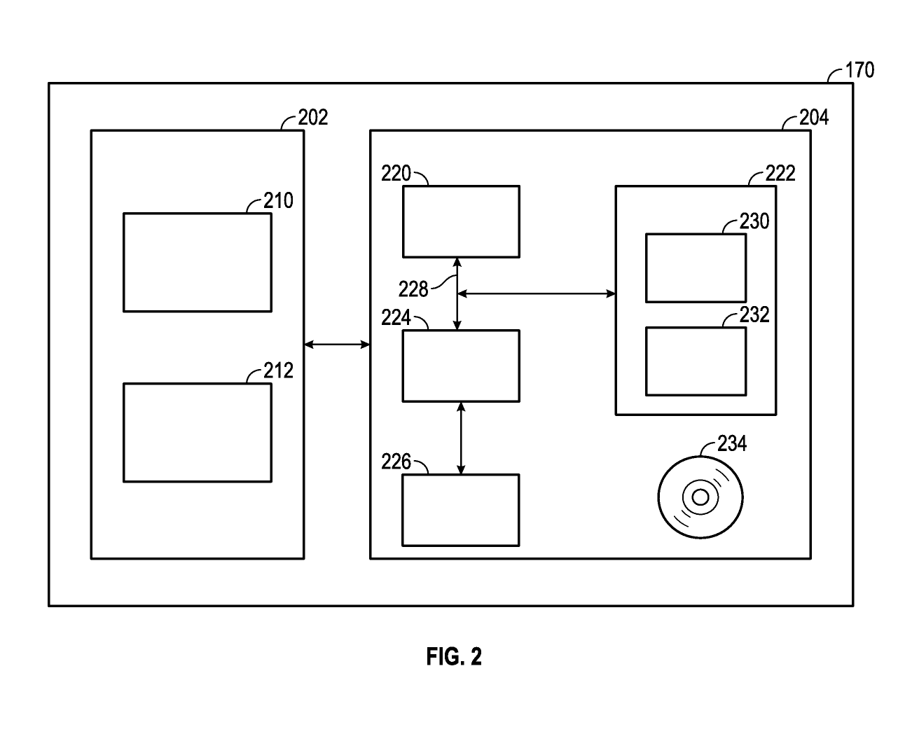

With reference to FIG. 2, a functional block diagram is provided for the control system 170, in accordance with an exemplary embodiment. As depicted in FIG. 2, the control system 170 includes a sensor array 202 and a controller 204.

The sensor array 202 measures and obtains information for use by the controller 204 pertaining to objects (for example, other vehicles) that may be proximate the vehicle 100 of FIG. 1. As depicted in FIG. 2, the sensor array 202 includes one or more vision sensors 210 and one or more radar sensors 212. In one embodiment, the vision sensors 210 comprise cameras, and the radar sensors 212 comprise short and/or long range radar detection devices. In certain embodiments, other types of sensors and/or other detection devices and/or techniques may be utilized, such as, by way of example, light detection and ranging (LIDAR), vehicle-to-vehicle (V2V) communications, lasers, ultrasounds, and/or other devices may be utilized, such as any other devices that add an input that provides range, bearing, or classification of objects of interest. In one embodiment, the vision sensors 210 and the radar sensors 212 are disposed in a front portion of the vehicle.

The controller 204 is coupled to the sensor array 202. The controller 204 processes the data and information received from the sensor array 202, and associates measurements therefrom pertaining to objects that may be proximate the vehicle. In one embodiment, the controller 204 performs these features in accordance with the steps of the processes 300, 500 depicted in FIGS. 3-5 and described further below in connection therewith.

As depicted in FIG. 2, the controller 204 comprises a computer system. In certain embodiments, the controller 204 may also include one or more of the sensors of the sensor array 202. In addition, it will be appreciated that the controller 204 may otherwise differ from the embodiment depicted in FIG. 2. For example, the controller 204 may be coupled to or may otherwise utilize one or more remote computer systems and/or other control systems.

In the depicted embodiment, the computer system of the controller 204 includes a processor 220, a memory 222, an interface 224, a storage device 226, and a bus 228. The processor 220 performs the computation and control functions of the controller 204, and may comprise any type of processor or multiple processors, single integrated circuits such as a microprocessor, or any suitable number of integrated circuit devices and/or circuit boards working in cooperation to accomplish the functions of a processing unit. During operation, the processor 220 executes one or more programs 230 contained within the memory 222 and, as such, controls the general operation of the controller 204 and the computer system of the controller 204, preferably in executing the steps of the processes described herein, such as the steps of the processes 300, 500 (and any sub-processes thereof) in connection with FIGS. 3-5.

The memory 222 can be any type of suitable memory. This would include the various types of dynamic random access memory (DRAM) such as SDRAM, the various types of static RAM (SRAM), and the various types of non-volatile memory (PROM, EPROM, and flash). In certain examples, the memory 222 is located on and/or co-located on the same computer chip as the processor 220. In the depicted embodiment, the memory 222 stores the above-referenced program 230 along with one or more stored values 232 (preferably, including look-up tables) for use in associating the measurements from the sensor array 202.

The bus 228 serves to transmit programs, data, status and other information or signals between the various components of the computer system of the controller 204. The interface 224 allows communication to the computer system of the controller 204, for example from a system driver and/or another computer system, and can be implemented using any suitable method and apparatus. It can include one or more network interfaces to communicate with other systems or components. The interface 224 may also include one or more network interfaces to communicate with technicians, and/or one or more storage interfaces to connect to storage apparatuses, such as the storage device 226.

The storage device 226 can be any suitable type of storage apparatus, including direct access storage devices such as hard disk drives, flash systems, floppy disk drives and optical disk drives. In one exemplary embodiment, the storage device 226 comprises a program product from which memory 222 can receive a program 230 that executes one or more embodiments of one or more processes of the present disclosure, such as the steps of the processes 300, 500 (and any sub-processes thereof) of FIGS. 3-5, described further below. In another exemplary embodiment, the program product may be directly stored in and/or otherwise accessed by the memory 222 and/or a disk (e.g., disk 234), such as that referenced below.

The bus 228 can be any suitable physical or logical means of connecting computer systems and components. This includes, but is not limited to, direct hard-wired connections, fiber optics, infrared and wireless bus technologies. During operation, the program 230 is stored in the memory 222 and executed by the processor 220.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 220) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will similarly be appreciated that the computer system of the controller 204 may also otherwise differ from the embodiment depicted in FIG. 2, for example in that the computer system of the controller 204 may be coupled to or may otherwise utilize one or more remote computer systems and/or other control systems.

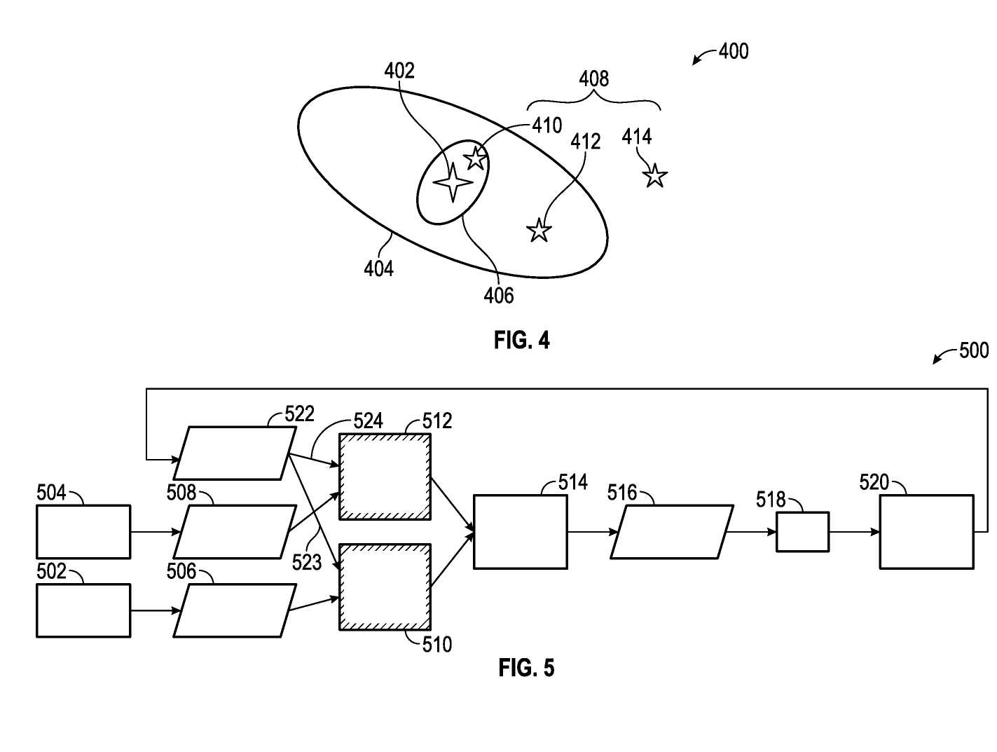

FIG. 3 is a flowchart of a process 300 for associating measurements of objects detected in proximity to a vehicle, in accordance with an exemplary embodiment. The process 300 can be used in connection with the vehicle 100 of FIG. 1 and the control system 170 of FIGS. 1 and 2, in accordance with an exemplary embodiment. The process 300 is also discussed below in conjunction with FIG. 4, which includes an illustration of exemplary tracking gates pertaining to the process 300, and in conjunction with FIG. 5, which provides a related process for associating measurements of objects detected in proximity to a vehicle, in accordance with an exemplary embodiment. The processes 300 and 500 are preferably performed continuously throughout an ignition cycle of the vehicle.

As depicted in FIG. 3, the process 300 includes the step of identifying an object (step 301). The object preferably comprises another vehicle or other moving or stationary object in proximity to the vehicle 100 of FIG. 1. The object is preferably identified by the processor 220 of FIG. 2 based on measurements provided by the sensor array 202 of FIG. 2. As the object is identified in step 301, the processor 220 preferably denotes a first tracking point 402 to represent the object, as shown in FIG. 4.

Additional measurements are also obtained (step 302). The additional measurements pertain to additional values of objects that may be in proximity to the vehicle, and the may pertain to the object identified in step 301. The additional measurements are preferably made by the sensor array 202 of FIG. 2 and provided to the processor 220 of FIG. 2 for processing. With reference to FIG. 4, the additional measurements are denoted with reference numeral 408. For illustrative purposes, as depicted in FIG. 4, the additional measurements 408 may include a first additional measurement 410, a second additional measurement 412, and a third additional measurement 414. It will be appreciated that there may be any number of such additional measurements 408.

In certain embodiments, the object is identified in step 301 based on a first measurement from a first sensor of the sensor array 202 of FIG. 2, and least some of the additional measurements are made by additional sensors of the sensor array 202 that are different from the first sensor. Also in certain embodiments, the object is identified in step 301 based on a measurement from a first point in time, and the additional measurements are made (either by the same sensor, additional sensors, or a combination thereof) at additional points in time that are subsequent to the first point in time.

Historical data is obtained (304). The historical data preferably pertains to a measurement history pertaining to the object identified in step 301, including the measurements used to identify the object in step 301 as well as the additional measurements of step 302. The historical data is preferably stored in the memory 222 of FIG. 2 as stored values 232 thereof for retrieval and use by the processor 220 of FIG. 2.

A first tracking gate is generated (step 306). The first tracking gate represents an initial boundary for tracking the measurements and associating them with the object identified in step 301. The first tracking gate is preferably generated by the processor 220 of FIG. 2 based on one or more characteristics of one or more of the sensors of the sensor array 202 used to obtain the measurements of step 302.

An exemplary first tracking gate 404 is depicted in FIG. 4. As shown in FIG. 4, the first tracking gate 404 is preferably elliptical in shape. In one embodiment, the first tracking gate is generated based on known or expected variances or errors in measurement values for a particular type of sensor of the sensor array 202 used to obtain the measurements. For example, the expected variances of a vision sensor (e.g. camera) 210 of FIG. 2 may have a different elliptical shape as compared with the expected variances of a radar sensor 212 of FIG. 2. Such information may be obtained previously, for example by experimentation, published reports, and/or manufacturer specifications, and stored in the memory 222 of FIG. 2 as stored values 232 thereof for retrieval and use by the processor 220 of FIG. 2. In one embodiment, multiple tracking gates are generated in step 306 (for example one tracking gate for a vision sensor 210 of FIG. 2 and another tracking gate for a radar sensor 212 of FIG. 2, and so on).

A second tracking gate is also generated (step 308). The second tracking gate represents an additional boundary for tracking the measurements and associating them with the object identified in step 301. The second tracking gate is preferably generated by the processor 220 of FIG. 2 based on the first tracking gate(s) of step 306 and the measurement history of step 304. The second tracking gate is preferably disposed within the boundaries of each tracking gate of step 306, so that the region defined with in the boundary of the second tracking gate is a subset of the region defined within the boundaries of the first tracking gates. In addition, the second tracking gate is preferably generated using a Kalman filter in conjunction with the measurement values of step 302, and preferably also along with prior knowledge of the sensor performance. The second tracking gate is preferably updated recursively as additional measurements are obtained and used for updated inputs for the Kalman filter, and preferably also along with prior knowledge of the sensor performance.

An exemplary second tracking gate 406 is depicted in FIG. 4. As shown in FIG. 4, the second tracking gate 406 is preferably elliptical in shape, but with a smaller elliptical shape that fits entirely within the boundaries of the first tracking gate 404. Also as shown in FIG. 4, the second tracking gate 406 also may have a different form of elliptical shape than the first tracking gate 404.

For each measurement of step 302, a determination is made as to whether the measurement falls within the boundary of the first tracking gate based on a comparison of the measurement with the first tracking gate (step 310). This determination is preferably made by the processor 220 of FIG. 2. With reference to the example of FIG. 4, the first and second additional measurements 410, 412 both fall within the boundary of the first tracking gate 404, while the third additional measurement 414 falls outside the boundary of the first tracking gate 404.

In certain embodiments in which multiple first tracking gates are used (e.g., for different types of sensors), the comparison of step 310 preferably comprises a determination of whether a measurement falls within the boundary of a particular first tracking gate that is associated with the type of sensor that was used for generating the particular measurement at issue. In one embodiment, the comparison comprises a probability score that the measurement falls within the boundary of the first tracking gate.

If it is determined in step 310 that the measurement is not within the boundary of the first tracking gate (i.e., if the measurement is outside the boundary, such as with the third additional measurement 414 of FIG. 4), then the measurement is not associated with the object (step 311). Specifically, during step 311, it is determined that the measurement at issue is not likely to represent the object identified in step 301, so the measurement is not used in further tracking of the object. The process then skips to step 320 (discussed further below), in which the historical data is updated accordingly. Step 310 is preferably performed by the processor 220 of FIG. 2.

Conversely, if it is determined in step 310 that the measurement is within the boundary of the first tracking gate (such as with the first and second additional measurements 410, 412 of FIG. 4), then the measurement is associated with the object (step 312). Specifically, during step 312, it is determined that the measurement at issue is likely to represent the object identified in step 301, so the measurement at issue is used in further tracking of the object. The process then proceeds to step 314, discussed below. Step 314 is preferably performed by the processor 220 of FIG. 2.

During step 314, a determination is also made (for each measurement falling within the boundary of the first tracking gate) as to whether the measurement also falls within the boundary of the second tracking gate based on a comparison of the measurement with the second tracking gate (step 314). This determination is preferably made by the processor 220 of FIG. 2. With reference to the example of FIG. 4, the first additional measurement 410 falls within the boundary of the second tracking gate 406, while the second and third additional measurements 412, 414 fall outside the boundary of the second tracking gate 406. In one embodiment, the comparison comprises a probability score that the measurement falls within the boundary of the second tracking gate.

If it is determined in step 314 that the measurement is not within the boundary of the second tracking gate (i.e., if the measurement is outside the boundary, such as with the second and third additional measurements 412, 414 in the example of FIG. 4), but is within the boundary of the first tracking gate (as determined in step 310), then the measurement is provided with a first level of weighting as a first measure of confidence that the measurement represents the object identified in step 301 (step 315). The first level of weighting may be used, for example, in continuing to track and predict movement and position of the object. The process then proceeds to step 320, as the historical data is updated (as discussed further below). Step 315 is preferably performed by the processor 220 of FIG. 2.

Conversely, if it is determined in step 314 that the measurement is within the boundary of the second tracking gate (such as with the first additional measurement 410 in the example of FIG. 4), then the measurement is provided with a second level of weighting as a second measure of confidence that the measurement represents the object identified in step 301 (step 316). The second level of weighting may be used, for example, in continuing to track and predict movement and position of the object. The second level of confidence of step 316 is greater than the first level of confidence of step 315. Accordingly, measurements that fall within the boundary of the second tracking gate are provided a greater level of confidence in representing the object identified in step 301, and are provided a greater level of weighting in tracking and predicting movement and position of the object. Step 316 is preferably performed by the processor 220 of FIG. 2. The process then proceeds to step 318, discussed directly below.

During step 318, the second tracking gate is updated. Specifically, in a preferred embodiment, the second gate is updated in a recursive manner by adding the measurements as new inputs into the Kalman filter from the previous iteration. As shown in FIG. 3, only measurements falling within the boundary of the second gate (as determined in step 314) are used as inputs for the Kalman filter in updating the second tracking gate. Step 318 is preferably performed by the processor 220 of FIG. 2. The process then proceeds to step 320, discussed directly below.

During step 320, the measurements and determinations of steps 302-318 are used to update the historical data. The updated historical data is preferably stored in the memory 222 of FIG. 2 as stored values 232 therein for use in step 304 in a subsequent iteration. The updated historical data will be used in the subsequent iteration in updating the second tracking gate in step 308 of the subsequent iteration. Accordingly, in a preferred embodiment, the second tracking gate is continually refined and made into a smaller (and more precise) ellipse with each iteration of the process 300, to thereby provide for potentially continually more accurate and precise results.

In addition, in certain embodiments, in the event that objects from several sensors have been grouped together, these objects may be disassociated if an incorrect association has occurred or a better match exists with another object. Accordingly, in one embodiment, the association history of the grouping is checked at each time step, and if after a specifiable (calibratable) number of cycles the data from the previously associated objects no longer warrant association or they have moved too far away from the currently associated track, the measurements that no longer match the fusion track will be removed from that track and either added to another fusion track, if there is a good match, or a new track will be created for that measurement.

FIG. 5 is a flowchart of a related process 500 for associating measurements of objects detected in proximity to a vehicle, in accordance with an exemplary embodiment. The process 500 can be used in connection with the process 300 of FIG. 3, the vehicle 100 of FIG. 1, and the control system 170 of FIGS. 1 and 2, in accordance with an exemplary embodiment. The process 500 is preferably performed along with the process 300 of FIG. 3 continuously throughout an ignition cycle of the vehicle.

As depicted in FIG. 5, the process 500 includes the step of obtaining measurements, determinations, and/or classifications from a first type of sensor (step 502). In one embodiment, during step 502 measurements are obtained from one or more vision sensors (for example, one or more cameras) 210 of FIG. 2 pertaining to an object that has already been identified (for example, during step 301 of the process 300 of FIG. 3). In another embodiment, classifications are obtained from such sensors (for example, pertaining to classification as to a particular type and/or size of the object). In yet another embodiment, determinations are obtained from such sensors (for example, pertaining to classification as to a particular type and/or size of the object).

Measurements, determinations, and/or classifications are also obtained from a second type of sensor (step 504). In one embodiment, during step 504 measurements are obtained from one or more radar sensors 212 of FIG. 2 pertaining to an object that has already been identified (for example, during step 301 of the process 300 of FIG. 3). In another embodiment, classifications are obtained from such sensors (for example, pertaining to classification as to a particular type and/or size of the object). In yet another embodiment, determinations are obtained from such sensors (for example, pertaining to classification as to a particular type and/or size of the object). During an initial iteration of steps 502 and 504, the measurements, determinations, and/or classifications may be referred to as initial measurements from the respective sensor types. During subsequent iterations of steps 502 and 504 (for example, as described below), the measurements, determinations, and/or classifications may be referred to as additional measurements. While steps for two types of sensors are depicted in FIG. 5, it will be appreciated that in various embodiments any number of different types of sensors (and/or other detection devices and/or techniques) may be utilized. For example, in various embodiments, various radars, cameras, lasers, ultrasounds, and/or other devices may be utilized, such as any other devices that add an input that provides range, bearing, or classification of objects of interest.

Targets are identified based on the measurements, determinations, and/or classifications (steps 506, 508). Specifically, during step 506, targets are identified based on the measurements, determinations, and/or classifications from the first type of sensor of step 502. Similarly, during step 508, targets are identified based on the measurements, determinations, and/or classifications from the second type of sensor of step 504. Accordingly, in one embodiment, vision sensor targets are identified in step 506, and radar sensor targets are identified in step 508. In certain embodiments, targets from three or more different types of sensors (and/or other detection devices and/or techniques) may be identified. In one embodiment, the targets of steps 506 and 508 pertain to different positions of the same object. In another embodiment, the targets of steps 506 and 508 pertain to different objects. In certain embodiments, the identifications of steps 506 and 508 are preferably performed by the processor 220 of FIG. 2. In certain other embodiments, the identifications are performed, in whole or in part, by the sensor array 202.

Data association algorithms are utilized with respect to the targets identified in steps 506, 508 (steps 510, 512). Specifically, during step 510, a data association algorithm for the first type of sensor (e.g., for a vision sensor) is used to generate a first tracking gate for the targets of step 506 based on the characteristics of the first type of sensor. Similarly, during step 512, a data association algorithm for the second type of sensor (e.g., for a radar sensor) is used to generate a first tracking gate for the targets of step 508 based on the characteristics of the second type of sensor. Accordingly, in one embodiment, steps 510 and 512 correspond to the creation of multiple first gates for different types of sensors in step 306 of the process 300 of FIG. 3, and as discussed above in connection therewith. Accordingly, with reference to FIG. 4, two different first tracking gates 404, one for each type of sensor, are generated. It will be appreciated that in different embodiments more than two types of sensors (and/or other detection devices and/or techniques) may be used, and therefore more than two first tracking gates may be generated. Steps 510 and 512 are preferably performed by the processor 220 of FIG. 2.

A fusion system is generated (step 514). The fusion system preferably corresponds to the second gate of step 308 of the process 300 of FIG. 3. The fusion system is preferably generated by the processor 220 in a manner similar to that described above in connection with step 308 of FIG. 3, but specifically using both of the first gates of steps 510, 512 along with the measurement values of steps 502-508, preferably using a recursive Kalman filter, and preferably also along with prior knowledge of the sensor performance (also similar to the discussion above in connection with FIG. 3). Also in one embodiment, the fusion system corresponds to the second tracking gate 406 of FIG. 4. Step 514 is preferably performed by the processor 220 of FIG. 2.

Fusion targets are generated (step 516). Specifically, fusion targets are generated using the fusion system of step 514, preferably by the processor 220 of FIG. 2. The fusion targets each represent an estimated position of the object (e.g., the object identified in step 301 of the process 300 of FIG. 3) based on the fusion system of step 514, which incorporates information from the measurements and targets of both types of sensors of steps 502-508. Accordingly, in an embodiment in which the first type of sensor of steps 502, 506 comprises a vision sensor and the second type of sensor of steps 504, 508 comprises a radar sensor, the fusion targets represent an aggregate measure of the object's position using all available information from both the vision sensor and the radar sensor.

An analysis of the fusion targets is performed (step 518) and used to generate a target motion model (step 520). Specifically, in one embodiment, a tracking of fusion targets of step 516 over time is used to generate a pattern of movement of the fusion targets over time. The target motion model is used to predict fusion targets into the future (step 522), preferably using the prior fusion targets of step 516 in conjunction with the target motion model (and associated pattern of movement) of step 520. Steps 518-522 are preferably performed by the processor 220 of FIG. 2.

In addition, additional measurements are obtained (preferably, from both types of sensors), and additional corresponding targets (preferably, also for both types of sensors) are identified in new iterations of steps 502-508. Such new iterations occur at a time that is subsequent to the time in which the previous iterations of steps 502-508 were performed.

The corresponding targets of the new iterations of steps 506 and 508 are compared with the predicted fusion targets of step 522 in steps 523 and 524, respectively, preferably by the processor 220 of FIG. 2. Specifically, in one embodiment, during step 523 the predicted fusion targets of step 522 are compared with the new vision targets from the new iteration of step 506, and the comparison is used to update the implementation of the vision data association algorithm in a new iteration of step 510. Similarly, in one embodiment, during step 524 the predicted fusion targets of step 522 are compared with the new radar targets from the new iteration of step 508, and the comparison is used to update the implementation of the radar data association algorithm in a new iteration of step 512.

The process then proceeds with a new iteration of steps 514-522, in which the fusion system is updated accordingly and used to generate updated fusion targets, an updated target motion model, updated predicted fusion targets, and so on, in a continuous loop. The process continues to repeat in this manner throughout the ignition cycle of the vehicle. Accordingly, with each iteration, the fusion system is updated accordingly, to provide for potentially greater accuracy and precision in tracking objects. Also, similar to the discussion above, it will be appreciated that while two types of sensors are mentioned in connection with FIG. 5 (e.g., vision sensors and radar sensors), it will be appreciated that any number of different types of sensors (and/or other object detection devices and/or techniques, such as vehicle to vehicle communications, and/or other devices and/or techniques) may be utilized in different embodiments.

Accordingly, methods and systems are provided for associating measurements pertaining to objects that may be detected proximate a vehicle. The disclosed methods and systems provide for tracking measurements pertaining to an object along multiple tracking gates. The disclosed methods and systems thus provide for potentially improved tracking of objects that may be proximate the vehicle.

It will be appreciated that the vehicle of FIG. 1, and/or the systems of FIGS. 1 and 2, including without limitation the control system 170, and/or components thereof, may vary in different embodiments. It will also be appreciated that various steps of the processes 300, 500 described herein in connection with FIGS. 3-5 may vary in certain embodiments. It will similarly be appreciated that various steps of the processes 300, 500 described herein in connection with FIGS. 3-5 may occur simultaneous with one another, and/or in a different order as presented in FIGS. 3-5 and/or as described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method comprising:
identifying an object proximate a vehicle;
obtaining one or more measurements or classifications that may potentially be associated with the object via one or more sensors;
generating a first tracking gate that is based at least in part on a characteristic of one of the sensors used to obtain the measurements; and
generating a second tracking gate that is based at least on part on the first tracking gate and a measurement history.

2. The method of claim 1, wherein the second tracking gate is disposed with a boundary defined by the first tracking gate.

3. The method of claim 1, further comprising:
updating the second tracking gate recursively using the measurements or classifications.

4. The method of claim 1, further comprising:
comparing the measurement with the first tracking gate;
comparing the measurement with the second tracking gate;
associating the measurement with the object with a first weighting if the measurement is within a boundary defined by the first tracking gate and not within a boundary define by the second tracking gate; and
associating the measurement with the object with a second weighting if the measurement is within the boundary defined by the second tracking gate, wherein the second weighting is greater than the first weighting.

5. The method of claim 1, wherein the second tracking gate is generated using a Kalman filter.

6. The method of claim 1, further comprising:
comparing the measurement with the second tracking gate; and
updating the second tracking gate with the measurement if the measurement is within a boundary defined by the second tracking gate.

7. The method of claim 6, wherein the step of comparing the measurement with the second tracking gate comprises calculating a probability score for the measurement with respect to the second tracking gate.

8. The method of claim 1, wherein:
the step of generating the first tracking gate comprises generating the first tracking gate that is based at least in part on a characteristic of a first type of sensor that is used to obtain the measurements;
the method further comprises generating a third tracking gate that is based at least in part on a characteristic of a second type of sensor that is used to obtain the measurements; and
the step of generating the second tracking gate comprises generating the second tracking gate based on at least on part on the first tracking gate, the second tracking gate, and the measurement history.

9. The method of claim 8, further comprising:
generating a predicted value using the measurements and the second tracking gate;
obtaining additional measurements;
comparing the predicted value and the additional measurements; and
updating the second tracking gate based on the comparison between the predicted value and the additional measurements.

10. A method comprising:
obtaining initial first measurements via a first type of sensor;
obtaining initial second measurements via a second type of sensor that is different from the first type of sensor;
generating a fusion system incorporating the initial first measurements and the initial second measurements;
generating a predicted value using the initial first measurements, the initial second measurements, and the fusion system;
obtaining additional measurements via the first type of sensor, the second type of sensor, or both; and
comparing the predicted value with the additional measurements.

11. The method of claim 10, wherein the step of obtaining the additional measurements comprises:
obtaining the additional measurements via the first type of sensor and the second type of sensor.

12. The method of claim 10, further comprising:
updating the fusion system using the comparison of the predicted value with the additional measurements.

13. A system comprising:
one or more sensors configured to provide one or more measurements; and
a processor coupled to the one or more sensors, the processor configured to at least facilitate:
identifying an object proximate a vehicle;
generating a first tracking gate that is based at least in part on a characteristic of one of the sensors used to obtain the measurements; and
generating a second tracking gate that is based at least on part on the first tracking gate and a measurement history.

14. The system of claim 13, wherein the processor is further configured to at least facilitate updating the second tracking gate recursively using the measurements.

15. The system of claim 13, wherein the processor is further configured to at least facilitate:
comparing the measurement with the first tracking gate;
comparing the measurement with the second tracking gate;
associating the measurement with the object with a first weighting if the measurement is within a boundary defined by the first tracking gate and not within a boundary defined by the second tracking gate; and
associating the measurement with the object with a second weighting if the measurement is within the boundary defined by the second tracking gate, wherein the second weighting is greater than the first weighting.

16. The system of claim 13, wherein the second tracking gate is generated using a Kalman filter.

17. The system of claim 13, wherein the processor is further configured to at least facilitate:
comparing the measurement with the second tracking gate; and
updating the second tracking gate with the measurement if the measurement is within a boundary defined by the second tracking gate.

18. The system of claim 17, wherein the processor is further configured to at least facilitate comparing the measurement with the second tracking gate by calculating a probability score for the measurement with respect to the second tracking gate.

19. The system of claim 13, wherein the processor is further configured to at least facilitate:
generating the first tracking gate based at least in part on a characteristic of a first type of sensor that is used to obtain the measurements;
generating a third tracking gate that is based at least in part on a characteristic of a second type of sensor that is used to obtain the measurements; and
generating the second tracking gate based on at least on part on the first tracking gate, the second tracking gate, and the measurement history.

20. The system of claim 19, wherein the processor is further configured to at least facilitate:
generating a predicted value using the measurements and the second tracking gate;
obtaining additional measurements;
comparing the predicted value and the additional measurements; and
updating the second tracking gate based on the comparison between the predicted value and the additional measurements.
